(19) United States
(12) Patent Application Publication
(10) Pub. No.: US 2024/0427586 A1
(43) Pub. Date: Dec. 26, 2024

(54) BIOS/OS COORDINATED UPDATE FOR AN INFORMATION HANDLING SYSTEM

(71) Applicant: Dell Products L.P., Round Rock, TX (US)

(72) Inventors: Ibrahim Sayyed, Georgetown, TX (US); Daniel Hamlin, Round Rock, TX (US); Shane L. Yarbrough, Tuscola, TX (US)

(73) Assignee: Dell Products L.P., Round Rock, TX (US)

(21) Appl. No.: 18/338,884

(22) Filed: Jun. 21, 2023

(51) Int. Cl. G06F 8/65

(52) U.S. Cl. CPC G06F 8/65

(57) ABSTRACT

Aspects of this disclosure implement a method of determining a dependency of a software on a firmware update and, based on determining the dependency, providing availability of an update package to a BIOS, the update package comprising a firmware update and dependency metadata. Once the processor of the information handling system has received an indication of completion of the firmware update, the software may be installed, wherein the software installation is performed based on the dependency being satisfied. Other aspects are also disclosed.

### FIELD OF THE DISCLOSURE

The instant disclosure relates to information handling systems. More specifically, portions of this disclosure relate to synchronizing software and firmware updates via bi-directional communication between the host operating system and BIOS/embedded controller.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

An information handling system may synchronize firmware and software updates to deliver modified solution components via operating system or firmware resident initiation paths and deliver trusted components for features supported by the original equipment manufacturer. Aspects of the disclosure implement a method of providing an update package to the BIOS comprising a firmware update and updating or installing software after completion of the firmware update based on a dependency of the software on the firmware update.

According to one embodiment, a method may comprise: determining, by an information handling system, a dependency of a software on a firmware update; based on determining the dependency: providing, by a processor of the information handling system, availability of an update package to a BIOS, the update package comprising a firmware update and dependency metadata; receiving, by the processor of the information handling system, a completion indicator created during execution of the BIOS indicative of a completion of the firmware update; and installing, by the information handling system, the software after receiving the completion indicator, wherein the software installation is performed based on the dependency being satisfied.

According to some embodiments of the disclosure, the completion indicator comprises an entry in a ACPI table. According to certain embodiments of the disclosure, the completion indicator comprises metadata stored in in an EFI system partition.

According to certain embodiments of the disclosure, the software comprises a listening feature for a free fall sensor and the firmware update comprises updating an integrated sensor hub, wherein the integrated sensor hub comprises a free fall sensor algorithm.

According to some embodiments of the disclosure, the software installation comprises installing a new software on the information handling system based, at least in part, on the dependency being satisfied.

According to certain embodiments of the disclosure, the software to be installed on the device comprises code for collecting telemetry data and providing the telemetry data to a backend server.

The method may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, audio controller, or similar electronic computing device that manipulates and transforms data represented as physical (electronic) quantities within the computer system's registers and memories into other data similarly represented as physical quantities within the computer system's registers, memories, or other such information storage, transmission, or display devices.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating bi-directional communications between the firmware and operating system of an information handling system according to certain embodiments of the disclosure.

FIG. 2 is a block diagram illustrating a dependency of a software on a firmware update according to certain embodiments of the disclosure.

FIG. 3 is a flowchart diagram illustrating a method of determining a dependency of a software update on a firmware update according to certain embodiments of the disclosure.

FIG. 4 is a flowchart diagram illustrating a method of a BIOS update enforcing software updates according to some embodiments of the disclosure.

FIG. 5 is a flowchart diagram illustrating a method of a software update requesting a firmware update based, at least in part, on its dependency on the firmware update according to certain embodiments of the disclosure.

FIG. 6 is a schematic block diagram of an example information handling system according to some embodiments of the disclosure.

### DETAILED DESCRIPTION

Aspects of the disclosure include apparatuses, configurations, and/or method for improving the synchronizing of firmware and software updates through bi-directional communication between these environments.

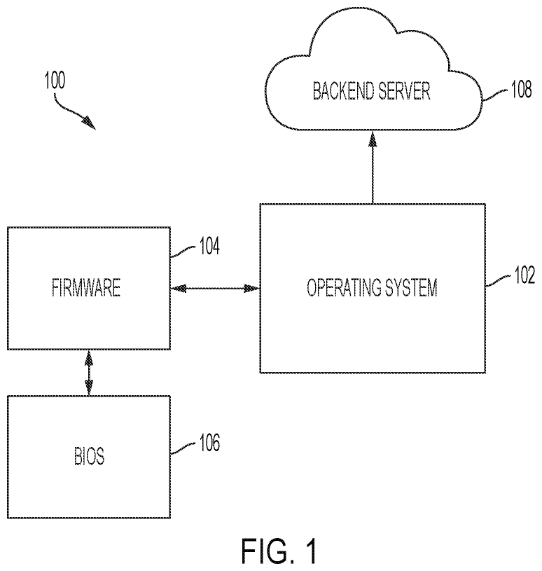

FIG. 1 illustrates bi-directional communications between the firmware and operating system of an information handling system according to certain embodiments of the disclosure. System 100 depicts an operating system 102 of an information handling system communicating with the firmware 104, such as an integrated sensor hub firmware via a host embedded controller interface. When the operating system 102 attempts to execute an application or software that is dependent on an update to firmware 104, there may be a requirement that the firmware update be performed through a BIOS 106 update. Technical support from the manufacturer, for example, may receive update and dependency data on the backend server 108.

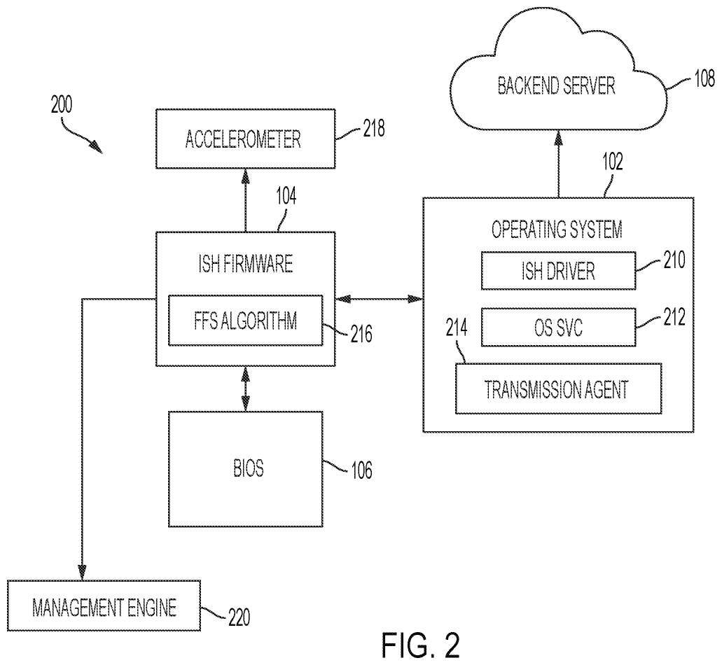

FIG. 2 illustrates a correlation between a software and a firmware update according to certain embodiments of the disclosure. System 200 depicts operating system 102 of an information handling system communicating with the integrated sensor hub firmware 104. According to some embodiments, the software may be an OS service application 212 in need of an update to perform certain features, such as a listening feature for a free fall sensor (FFS). The ISH firmware 104 may comprise an FFS algorithm 216, which communicates with the ISH driver 210 of the operating system 102 and a peripheral such as an accelerometer 218. The management engine 220 provides a communications path for the operating system 102 to communicate with the firmware 104 and verify that the system software remains current and compatible with other system modules such as firmware 104, BIOS 106, drivers, and other software. According to one embodiment, the FFS may require an update to the OS service application 212 for performing certain features, such as the FFS listening feature. Adding or modifying the FFS listening feature in the OS service application 212 may be dependent on also updating the FFS algorithm 216 inside of the ISH firmware 104. A coordinated update between BIOS and O/S may include an update for ISH firmware 104 to provide certain new or modified functionality such that the OS service 212 can listen to FFS notifications through the sensor application programming interface. The management engine 220 may communicate this dependency and push a firmware update to ISH firmware 104 to be applied based on the dependency with the O/S update before the O/S updates software executed by the O/S (such as service 212). Further, technical support from the manufacturer may receive updates and dependency data on the backend server 108, such as through transmission agent 214, without affecting the operation of the information handling system.

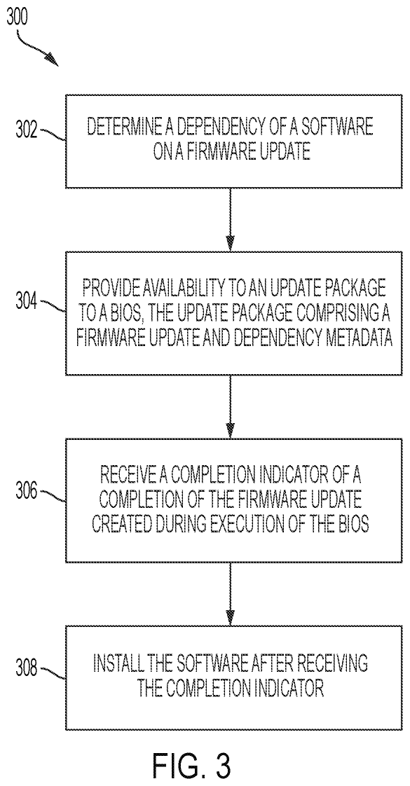

FIG. 3 illustrates a method of determining a dependency of a software update on a firmware update according to certain embodiments of the disclosure. Method 300 demonstrates determining, by an information handling system, a dependency of a software on a firmware update at block 302. The software may be, for example, a new software package for installation, a new operating system service for installation, a new operating system feature for installation, a new operating system version for installation, or a update to an already-installed version of one or a combination of these software. Then, based on determining the dependency: providing, by a processor of the information handling system, availability of an update package to a BIOS, the update package comprising a firmware update and dependency metadata at block 304. For example, the update package may be loaded in a portion of memory and a flag set to indicate to the processor while executing the BIOS during a boot cycle to retrieve the update package from the memory location. The firmware update may be applied by, for example, an embedded controller (EC) in the information handling system or a processor in the information handling system during a pre-boot or boot phase (such as while execution BIOS code). This firmware update may occur, for example, during a reboot requested by the information handling system after preparing the update package. After the update package is applied, the information handling system may reboot and/or continue boot such that the updated firmware is active in the component. The operating system executing on the information handling system proceeds to receive a completion indicator created during execution of the BIOS indicative of a completion of the firmware update at block 306. After receiving the completion indicator of the firmware update, the software may be installed, at block 308, by the operating system of the information handling system wherein the software installation is performed based on the dependency being satisfied.

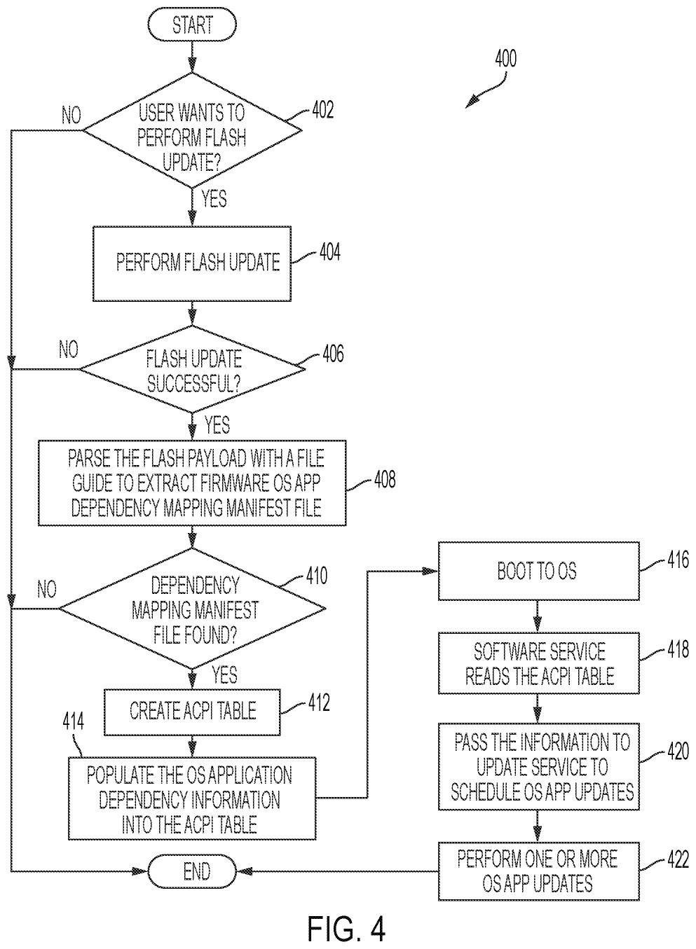

FIG. 4 illustrates a method 400 of a BIOS update enforcing software updates according to some embodiments of the disclosure. The information handling system confirms that a user wants to perform a flash update at block 402. If so, the method 400 continues to block 404 wherein the information handling system performs the flash update and determines if the flash update was successful at block 406. If the flash update was successful, the information handling system parses the flash payload with a file guide to extract firmware operating system application dependency mapping manifest file at block 408. The manifest file contains information on applications and revision updates that need to be refreshed to synchronize with the platform firmware update to allow new auto-heal/diagnostic/telemetry additions. The manifest file may be part of the main BIOS executable. If the dependency mapping manifest file is found at block 410, the information handling system creates an ACPI table at block 412 to populate the application dependency information into the ACPI table at block 414. Alternatively, according to some embodiments, the manifest file may be copied to an EFI system partition (ESP). According to other embodiments, rather than a manifest file, the processor may receive a completion indicator created during execution of the BIOS which may be indicative of a completion of the firmware update. In such an embodiment, the completion indicator may comprise an entry in a ACPI table or metadata to be stored in an ESP. The system then boots to OS at block 416 where the software service reads the ACPI table at block 418. At block 420, the information is passed to an update service to schedule operating system application updates so that the one or more application updates may be performed at block 422.

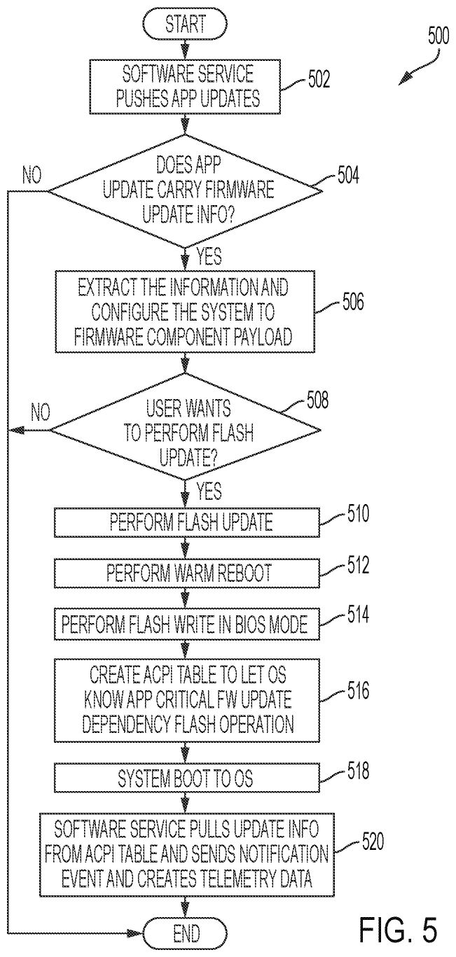

FIG. 5 illustrates a method 500 of a software update requesting a firmware update based, at least in part, on its dependency on the firmware update according to certain embodiments of the disclosure. At block 502, the software service pushes application updates. If the system determines the application to carry firmware update information, such as dependency information, at block 504, the system extracts the information and configures the system to firmware component payload at block 506. The system receives user consent to perform a flash update at block 508, such as by prompting and/or notifying the user that the application update has a firmware update dependency. Upon receiving user consent, the system performs the flash update at block 510, performs a warm reboot at block 512, and finally performs flash write in BIOS mode at block 514. If the result of the firmware update status is unsuccessful, such as the update failed or aborted, the application update may be rescheduled for a later time after the BIOS update revision has been changed. At block 516, the system creates an ACPI table to inform the operating system of the applications critical firmware update dependency flash operation. As mentioned regarding method 400 referring to FIG. 4, the system may utilize an EFI system partition (ESP) rather than an ACPI table according to certain embodiments of the disclosure. According to other embodiments, rather than a manifest file, the processor may receive a completion indicator created during execution of the BIOS which may be indicative of a completion of the firmware update. In such an embodiment, the completion indicator may comprise an entry in an ACPI table or metadata to be stored in an ESP. Then the system boots to the operating system at block 518 before the software service pull the update information from the ACPI table (or ESP). The software service may send a notification event and create telemetry data at block 520, which may be provided to a backend server.

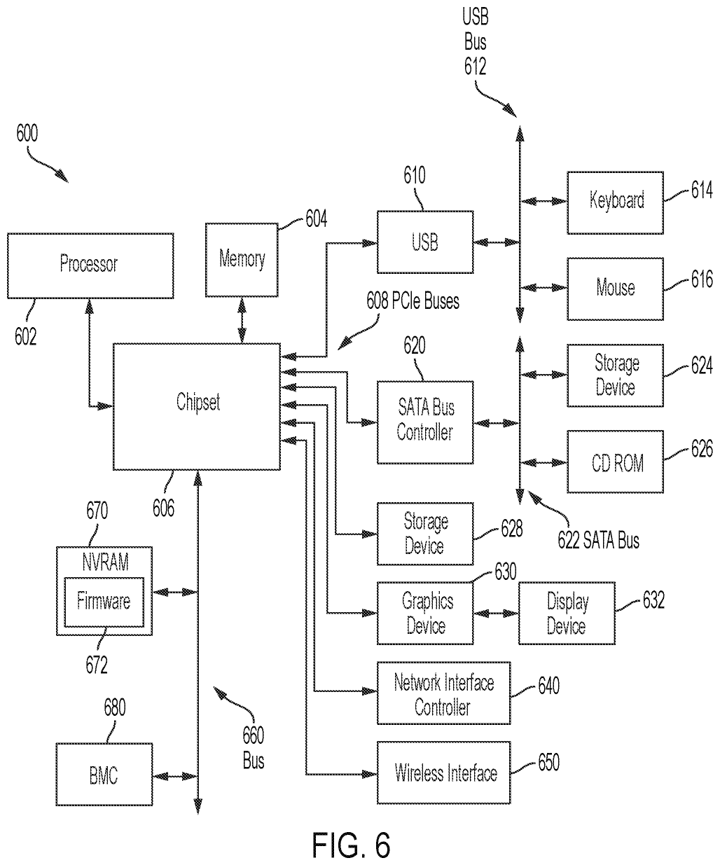

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components. One example configuration of an information handling system is described with reference to FIG. 6.

FIG. 6 illustrates an example information handling system 600. Information handling system 600 may include a processor 602 (e.g., a central processing unit (CPU)), a memory (e.g., a dynamic random-access memory (DRAM)) 604, and a chipset 606. In some embodiments, one or more of the processor 602, the memory 604, and the chipset 606 may be included on a motherboard (also referred to as a mainboard), which is a printed circuit board (PCB) with embedded conductors organized as transmission lines between the processor 602, the memory 604, the chipset 606, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 602, the memory 604, the chipset 606, and/or other components may be organized as a System on Chip (SoC).

The processor 602 may execute program code by accessing instructions loaded into memory 604 from a storage device, executing the instructions to operate on data also loaded into memory 604 from a storage device, and generate output data that is stored back into memory 604 or sent to another component. The processor 602 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 602 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 606 may facilitate the transfer of data between the processor 602, the memory 604, and other components. In some embodiments, chipset 606 may include two or more integrated circuits (ICs), such as a northbridge controller coupled to the processor 602, the memory 604, and a southbridge controller, with the southbridge controller coupled to the other components such as USB 610, SATA 620, and PCIe buses 608. The chipset 606 may couple to other components through one or more PCIe buses 608.

Some components may be coupled to one bus line of the PCIe buses 608, whereas some components may be coupled to more than one bus line of the PCIe buses 608. One example component is a universal serial bus (USB) controller 610, which interfaces the chipset 606 to a USB bus 612. A USB bus 612 may couple input/output components such as a keyboard 614 and a mouse 616, but also other components such as USB flash drives, or another information handling system. Another example component is a SATA bus controller 620, which couples the chipset 606 to a SATA bus 622. The SATA bus 622 may facilitate efficient transfer of data between the chipset 606 and components coupled to the chipset 606 and a storage device 624 (e.g., a hard disk drive (HDD) or solid-state disk drive (SDD)) and/or a compact disc read-only memory (CD-ROM) 626. The PCIe bus 608 may also couple the chipset 606 directly to a storage device 628 (e.g., a solid-state disk drive (SDD)). A further example of an example component is a graphics device 630 (e.g., a graphics processing unit (GPU)) for generating output to a display device 632, a network interface controller (NIC) 640, and/or a wireless interface 650 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 606 may also be coupled to a serial peripheral interface (SPI) and/or Inter-Integrated Circuit (I2C) bus 660, which couples the chipset 606 to system management components. For example, a non-volatile random-access memory (NVRAM) 670 for storing firmware 672 may be coupled to the bus 660. As another example, a controller, such as a baseboard management controller (BMC) 680, may be coupled to the chipset 606 through the bus 660. BMC 680 may be referred to as a service processor or embedded controller (EC). Capabilities and functions provided by BMC 680 may vary considerably based on the type of information handling system. For example, the term baseboard management system may be used to describe an embedded processor included at a server, while an embedded controller may be found in a consumer-level device. As disclosed herein, BMC 680 represents a processing device different from processor 602, which provides various management functions for information handling system 600. For example, an embedded controller may be responsible for power management, cooling management, and the like. An embedded controller included at a data storage system may be referred to as a storage enclosure processor or a chassis processor.

System 600 may include additional processors that are configured to provide localized or specific control functions, such as a battery management controller. Bus 660 can include one or more busses, including a Serial Peripheral Interface (SPI) bus, an Inter-Integrated Circuit (I2C) bus, a system management bus (SMBUS), a power management bus (PMBUS), or the like. BMC 680 may be configured to provide out-of-band access to devices at information handling system 600. Out-of-band access in the context of the bus 660 may refer to operations performed prior to execution of firmware 672 by processor 602 to initialize operation of system 600.

Firmware 672 may include instructions executable by processor 102 to initialize and test the hardware components of system 600. For example, the instructions may cause the processor 602 to execute a power-on self-test (POST). The instructions may further cause the processor 602 to load a boot loader or an operating system (OS) from a mass storage device. Firmware 672 additionally may provide an abstraction layer for the hardware, such as a consistent way for application programs and operating systems to interact with the keyboard, display, and other input/output devices. When power is first applied to information handling system 600, the system may begin a sequence of initialization procedures, such as a boot procedure or a secure boot procedure. During the initialization sequence, also referred to as a boot sequence, components of system 600 may be configured and enabled for operation and device drivers may be installed. Device drivers may provide an interface through which other components of the system 600 can communicate with a corresponding device. The firmware 672 may include a basic input-output system (BIOS) and/or include a unified extensible firmware interface (UEFI). Firmware 672 may also include one or more firmware modules of the information handling system. Additionally, configuration settings for the firmware 672 and firmware of the information handling system 600 may be stored in the NVRAM 670. NVRAM 670 may, for example, be a non-volatile firmware memory of the information handling system 600 and may store a firmware memory map namespace 600 of the information handling system. NVRAM 670 may further store one or more container-specific firmware memory map namespaces for one or more containers concurrently executed by the information handling system.

Information handling system 600 may include additional components and additional busses, not shown for clarity. For example, system 600 may include multiple processor cores (either within processor 602 or separately coupled to the chipset 606 or through the PCIe buses 608), audio devices (such as may be coupled to the chipset 606 through one of the PCIe busses 608), or the like. While a particular arrangement of bus technologies and interconnections is illustrated for the purpose of example, one of skill will appreciate that the techniques disclosed herein are applicable to other system architectures. System 600 may include multiple processors and/or redundant bus controllers. In some embodiments, one or more components may be integrated together in an integrated circuit (IC), which is circuitry built on a common substrate. For example, portions of chipset 606 can be integrated within processor 602. Additional components of information handling system 600 may include one or more storage devices that may store machine-executable code, one or more communications ports for communicating with external devices, and various input and output (I/O) devices, such as a keyboard, a mouse, and a video display.

In some embodiments, processor 602 may include multiple processors, such as multiple processing cores for parallel processing by the information handling system 600. For example, the information handling system 600 may include a server comprising multiple processors for parallel processing. In some embodiments, the information handling system 600 may support virtual machine (VM) operation, with multiple virtualized instances of one or more operating systems executed in parallel by the information handling system 600. For example, resources, such as processors or processing cores of the information handling system may be assigned to multiple containerized instances of one or more operating systems of the information handling system 600 executed in parallel. A container may, for example, be a virtual machine executed by the information handling system 600 for execution of an instance of an operating system by the information handling system 600. Thus, for example, multiple users may remotely connect to the information handling system 600, such as in a cloud computing configuration, to utilize resources of the information handling system 600, such as memory, processors, and other hardware, firmware, and software capabilities of the information handling system 600. Parallel execution of multiple containers by the information handling system 600 may allow the information handling system 600 to execute tasks for multiple users in parallel secure virtual environments.

The schematic flow chart diagrams of FIGS. 3, 4, and 5 are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Certain elements of embodiments described in this specification have been labeled as modules. A module may include a component of that information handling system suitably programmed to operate according to executable instructions. For example, a module may be implemented as a hardware circuit comprising custom VLSI circuits or gate arrays, semiconductor chips comprising logic circuitry, transistors, or other discrete components. A module may also be implemented in programmable hardware devices such as field programmable gate arrays, programmable array logic, programmable logic devices, a controller, or the like.

Modules may also include software-defined units or instructions that, when executed by a component of an information handling system, retrieve and transform data stored on a data storage device from a first state to a second state. An identified module of executable code may, for example, comprise one or more physical blocks of computer instructions which may be organized as an object, procedure, or function. The executables of an identified module need not be physically located together, but may comprise disparate instructions stored in different locations which, when joined logically together, comprise the module, and when executed by the processor, achieve the stated data transformation.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

The operations described above as performed by a controller may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuitry may be configured as a general purpose processor capable of executing instructions contained in software and/or firmware.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Further, a device or system that is configured in a certain way is configured in at least that way, but it can also be configured in other ways than those specifically described. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
determining, by an information handling system, a dependency of a software on a firmware update;
based on determining the dependency:
providing, by a processor of the information handling system, availability of an update package to a BIOS, the update package comprising a firmware update and dependency metadata;
receiving, by the processor of the information handling system, a completion indicator created during execution of the BIOS indicative of a completion of the firmware update; and
installing, by the information handling system, the software after receiving the completion indicator, wherein the software installation is performed based on the dependency being satisfied.

2. The method of claim 1, wherein the completion indicator comprises an entry in a ACPI table.

3. The method of claim 1, wherein the completion indicator comprises metadata stored in in an EFI system partition.

4. The method of claim 1, wherein the software comprises a listening feature for a free fall sensor and the firmware update comprises updating an integrated sensor hub.

5. The method of claim 4, wherein the integrated sensor hub comprises a free fall sensor algorithm.

6. The method of claim 1, wherein the software installation comprises installing a new software on the information handling system based, at least in part, on the dependency being satisfied.

7. The method of claim 1, wherein the software to be installed on the device comprises code for collecting telemetry data and providing the telemetry data to a backend server.

8. An information handling system, comprising:
a memory;
a processor coupled to the memory, wherein the processor is configured to perform steps comprising:
determining a dependency of a software on a firmware update;
based on determining the dependency:
providing availability of an update package to a BIOS, the update package comprising a firmware update and dependency metadata;
receiving a completion indicator created during execution of the BIOS indicative of a completion of the firmware update; and
installing the software after receiving the completion indicator, wherein the software installation is performed based on the dependency being satisfied.

9. The information handling system of claim 8, wherein the completion indicator comprises an entry in a ACPI table.

10. The information handling system of claim 8, wherein the completion indicator comprises metadata stored in in an EFI system partition.

11. The information handling system of claim 8, wherein the software comprises a listening feature for a free fall sensor and the firmware update comprises updating an integrated sensor hub.

12. The information handling system of claim 11, wherein the integrated sensor hub comprises a free fall sensor algorithm.

13. The information handling system of claim 8, wherein the software installation comprises installing a new software on the information handling system based, at least in part, on the dependency being satisfied.

14. The information handling system of claim 8, wherein the software to be installed on the device comprises code for collecting telemetry data and providing the telemetry data to a backend server.

15. A computer program product, comprising:
a non-transitory computer readable medium comprising code for performing steps comprising:
determining a dependency of a software on a firmware update;
based on determining the dependency:
providing availability of an update package to a BIOS, the update package comprising a firmware update and dependency metadata;
receiving a completion indicator created during execution of the BIOS indicative of a completion of the firmware update; and
installing the software after receiving the completion indicator, wherein the software installation is performed based on the dependency being satisfied.

16. The computer program product of claim 15, wherein the completion indicator comprises an entry in a ACPI table.

17. The computer program product of claim 15, wherein the completion indicator comprises metadata stored in in an EFI system partition.

18. The computer program product of claim 15, wherein the software comprises an free fall sensor algorithm and the firmware update comprises updating an integrated sensor hub.

19. The computer program product of claim 15, wherein the software installation comprises installing a new software on the information handling system based, at least in part, on the dependency being satisfied.

20. The computer program product of claim 15, wherein the software to be installed on the device comprises code for collecting telemetry data and providing the telemetry data to a backend server.
